(19) United States
(12) Patent Application Publication
(10) Pub. No.: US 2020/0281803 A1
(43) Pub. Date: Sep. 10, 2020

(54) EXOSKELETON ROBOT CONTROL SYSTEM AND METHODS FOR CONTROLLING EXOSKELETON ROBOT

(71) Applicant: FREE BIONICS TAIWAN INC., Hsinchu City (TW)

(72) Inventors: MING-CHANG TENG, HSINCHU CITY (TW); KUAN-CHUN SUN, HSINCHU COUNTY (TW); YI-JENG TSAI, TAOYUAN CITY (TW)

(21) Appl. No.: 16/292,892

(22) Filed: Mar. 5, 2019

(51) Int. Cl. A61H 3/02; A61H 1/02; A45B 9/02; A45B 9/04

(52) U.S. Cl. CPC A61H 3/02; A61H 1/0262; A45B 9/02; A61H 2201/5007; A61H 2201/5084; A61H 2201/5069; A45B 9/04

(57) ABSTRACT

The present disclosure provides an exoskeleton robot control system, including an exoskeleton robot coupled to a user, a first crutch configured to be held by a user, wherein the first crutch is physically separated from the exoskeleton robot, a trajectory sensor disposed on the first crutch, wherein the trajectory sensor is configured to detect a trajectory of the first crutch, and a control unit configured to generate an instruction based on the detected trajectory of the first crutch, wherein the instruction is received by the exoskeleton robot, and a subsequent movement of the exoskeleton robot is decided by the instruction.

### BACKGROUND

An exoskeleton robot system incorporates a wearable machine that can aid a user to walk. Specifically, the exoskeleton robot can allow paraplegic patients or people having trouble walking to move. Generally, an exoskeleton is powered by a system of electric motors, pneumatics, levers, hydraulics, or a combination of technologies that can move limbs.

An exoskeleton robot system may also include one or more walking assist or aid devices, such as a crutch, a pair of crutch, a walker, a crane, or the like. Such walking assist or aid devices can help achieve balance of the user during movement. In order to facilitate the performance of the exoskeleton robot, improvement on controlling the exoskeleton robot is highly entailed.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a perspective view of an exoskeleton robot, in accordance with some embodiments of the present disclosure.

FIG. 1B is a front view of an exoskeleton robot, in accordance with some embodiments of the present disclosure.

FIG. 1C is a side view of an exoskeleton robot, in accordance with some embodiments of the present disclosure.

FIG. 2 shows a flow chart representing method for controlling an exoskeleton robot, in accordance with some embodiments of the present disclosure.

FIG. 3 is a schematic drawing illustrating an exoskeleton robot control system, in accordance with some embodiments of the present disclosure.

FIG. 4A is a perspective view of a crutch, in accordance with some embodiments of the present disclosure.

FIG. 4B is a schematic drawing of a control box disposed on a crutch, in accordance with some embodiments of the present disclosure.

FIG. 4C is an enlarged perspective view of a tip of a crutch, in accordance with some embodiments of the present disclosure.

FIG. 5A shows a flow chart representing method for controlling an exoskeleton robot, in accordance with some embodiments of the present disclosure.

FIG. 5B shows a flow chart representing method for generating a trajectory signal, in accordance with some embodiments of the present disclosure.

FIG. 6A shows a flow chart representing method for controlling an exoskeleton robot, in accordance with some embodiments of the present disclosure.

FIG. 6B shows a diagram representing comparison between a trajectory of a first crutch and a plurality of trajectory data, in accordance with some embodiments of the present disclosure.

FIG. 7A is a perspective view of a first crutch and a second crutch, in accordance with some embodiments of the present disclosure.

FIG. 7B is a schematic drawing illustrating an exoskeleton robot control system, in accordance with some embodiments of the present disclosure.

FIG. 8A shows a flow chart representing method for obtaining a tilt angle of a user, in accordance with some embodiments of the present disclosure.

FIG. 8B is a schematic drawing showing a relative position of a user, a first crutch, and a second crutch, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the terms “substantially,” “approximately,” or “about” generally means within a value or range which can be contemplated by people having ordinary skill in the art. Alternatively, the terms “substantially,” “approximately,” or “about” means within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately,” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

An exoskeleton robot can be coupled to a user and thereby support the user to walk with improved mobility. Specifically, comparing to using a wheelchair, utilizing the exoskeleton robot allows a user to overcome obstructions more easily. In order to further improve the performance of the exoskeleton robot, various types of methods for controlling an exoskeleton robot have been developed. For example, the exoskeleton robot can receive an instruction, so that the exoskeleton robot can move, sit, walk, run, stop in accordance with the user's intention.

Conventionally, a position of a user's forearm or a distance between the tip of the crutch and the exoskeleton robot can be measured, and thereby used as a direct instruction for controlling the exoskeleton robot. Specifically, a position of a user's forearm or a relative position of a crutch tip with respect to the user's foot is measured by camera, optical range finders, ultrasonic range finders, or roughly by accelerometer/gyro package. However, during the course of moving, a user may need to adjust the position of a crutch to adapt various types of environments, or the user may move the crutch or arms without intention to send an instruction to the exoskeleton robot. Under such circumstances, the process of instructing the exoskeleton robot may be easily interfered. In addition, the use of camera, optical range finders, or ultrasonic range finders may be limited due to obstructions (for example, in a crowded area) or environmental noises, wherein such obstructions may deteriorate the performance of the exoskeleton robot, therefore further improvement is entailed.

In order to provide a more accurate control over the exoskeleton robot and to alleviate undesirable instructional signals during using the exoskeleton robot, the present disclosure provides an exoskeleton robot control system and methods for controlling an exoskeleton robot. Specifically, a user can control the exoskeleton by a crutch. Some of the embodiments provide an exoskeleton robot control system with sensors incorporated on the crutch to obtain more accurate movement and/or relative position between the crutch and the user. By incorporating sensors on the crutch, obstructions hindering the detection of a trajectory or an orientation of the crutch can be alleviated. In some of the embodiments, since the crutch can bear a portion of user's weight, by incorporating the sensors on the crutch, the user may be free from being coupled to heavy sensors such as camera, optical range finders, ultrasonic range finders, sensor packages. Some of the embodiments provide an exoskeleton robot control system configured with triggers to avoid unintentional instructions when the user has no intention to instruct the exoskeleton robot. The present disclosure further provides methods for controlling an exoskeleton robot with improved accuracy, for example, with regard to incorporating sensors on the crutch, adjustment on detected signal can be performed, and a tilt angle of the user can be detected to decide if current posture should be adjusted.

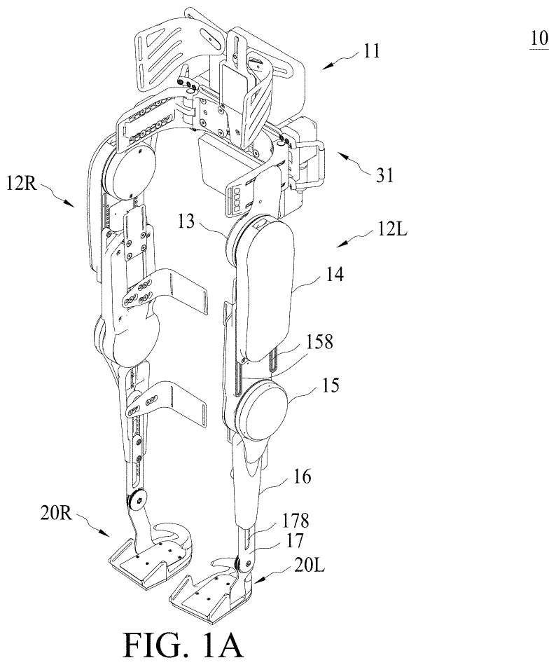

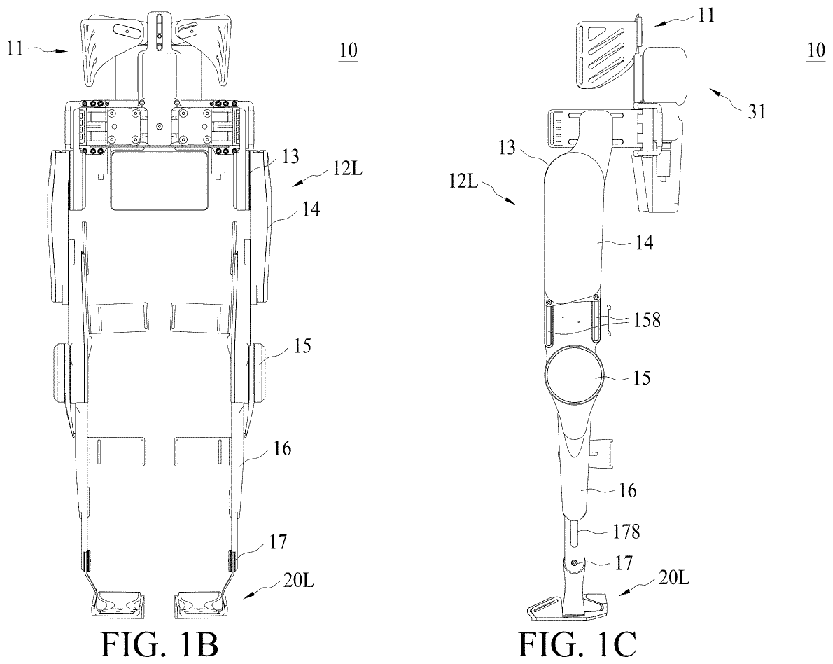

Referring to FIG. 1A, FIG. 1B, and FIG. 1C, FIG. 1A is a perspective view of an exoskeleton robot, FIG. 1B is a front view of an exoskeleton robot, FIG. 1C is a side view of an exoskeleton robot, in accordance with some embodiments of the present disclosure. The exoskeleton robot 10 at least includes a waist assembly 11, a right leg assembly 12R, and a left leg assembly 12L. The exoskeleton robot 10 may optionally include a right shoe assembly 20R and a left shoe assembly 20L.

The waist assembly 11 is configured to be coupled to a user's waist to provide support. The right leg assembly 12R and the left leg assembly 12L are respectively pivotally connected to the waist assembly 11 via a hip joint 13. Thereby the right leg assembly 12R and the left leg assembly 12L are rotatable with respect to the waist assembly 11. Since the right leg assembly 12R and the left leg assembly 12L can be physically symmetric to each other, for conciseness, only the left leg assembly 12L is discussed as duplicated explanations are omitted.

The left leg assembly 12L may include a thigh stand 14, a shank stand 16, a knee joint 15 and an ankle joint 17 in addition to the hip joint 13. The thigh stand 14, having an elongated shape, is pivotally connected at one side (not numbered) to the waist assembly 11 via the hip joint 13, and pivotally connected at another side (not numbered) to the shank stand 16 via the knee joint 15. Thereby the thigh stand 14 and the shank stand 16 are rotatable with respect to the knee joint 15. Optionally, the thigh stand 14 may be adjustable with the configuration of a first adjusting means 158 of the knee joint 15 in the elongated direction so that the length of the left leg assembly 12L at the thigh portion is adjustable to suit the user's need. In some embodiments, the first adjusting means 158 includes a pair of slots stretched in the elongated direction. In other embodiments, the first adjusting means 158 may include grooves, rails or sliding rods that facilitate the adjustment lengthwise.

The shank stand 16, also having an elongated shape, is pivotally connected at one side (not numbered) to the thigh stand 14 via the knee joint 15, and pivotally connected at another side (not numbered) to the shoe assembly 20 via the ankle joint 17. Thereby the shank stand 16 and the left shoe assembly 20L are rotatable with respect to the ankle joint 17. Optionally, the shank stand 14 may be adjustable with the configuration of a second adjusting means 178 of the ankle joint 17 in the elongated direction so that the length of the left leg assembly 12L at the shank portion is adjustable to suit the user's need. In some embodiments, the second adjusting means 178 includes a slot stretched in the elongated direction. Alternatively, the second adjusting means 178 may include grooves, rails or sliding rods that facilitate the adjustment lengthwise.

The structure of the exoskeleton robot 10 can be substituted by various forms, for example, known exoskeleton robots (or known counterparts of at least one of the waist assembly 11, the thigh stand 14, the shank stand 16, the hip joint 13, the knee joint 15, the ankle joint 17, the right shoe assembly 20R and the left shoe assembly 20L of the exoskeleton robot) set forth in U.S. Pat. No. 9,687,409, entitled “Walking Assist Device”, U.S. application Ser. No. 15/808,558, entitled “Exoskeleton Robot and Controlling Method for Exoskeleton Robot”, and U.S. application Ser. No. 15/811,102, entitled “Exoskeleton Robot”, which are herein incorporated by reference in its entirety. The right shoe assembly 20R and the left shoe assembly 20L can be substituted by various forms, for example, known U.S. application Ser. No. 15/811,137, entitled “Shoe Assembly for a Walking Assist Device”, which is herein incorporated by reference in its entirety. The details of the particular structure of the exoskeleton robot 10 can be referred to the aforesaid incorporated references, thus the redundant explanations are omitted herein.

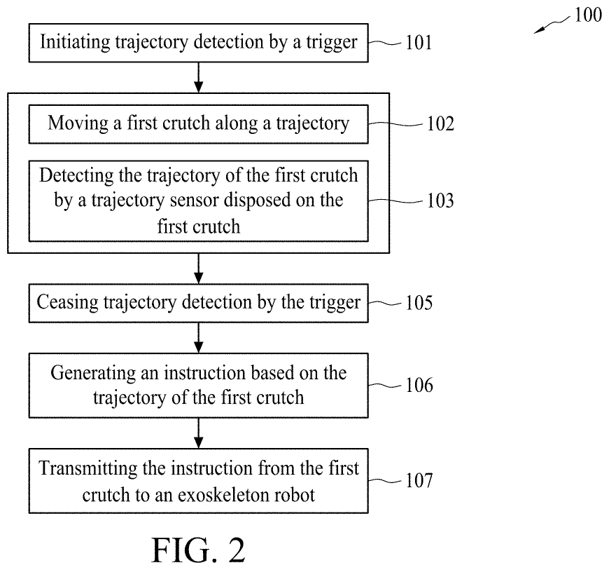

Referring to FIG. 2, FIG. 2 shows a flow chart representing method for controlling an exoskeleton robot, in accordance with some embodiments of the present disclosure. A method 100 at least includes moving a first crutch along a trajectory (operation 102), detecting the trajectory of the first crutch by a trajectory sensor disposed on the first crutch (operation 103), generating an instruction based on the trajectory of the first crutch (operation 106), and transmitting the instruction from the first crutch to an exoskeleton robot (operation 107). The method 100 may optionally include initiating trajectory detection by a trigger (operation 101) and ceasing trajectory detection by the trigger (operation 105).

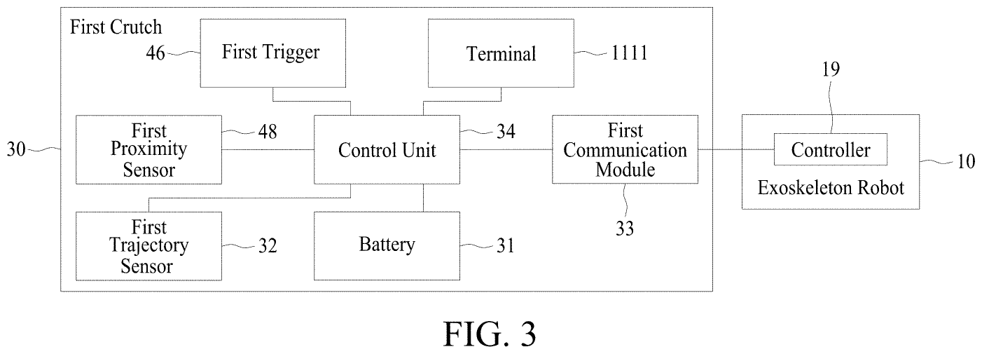

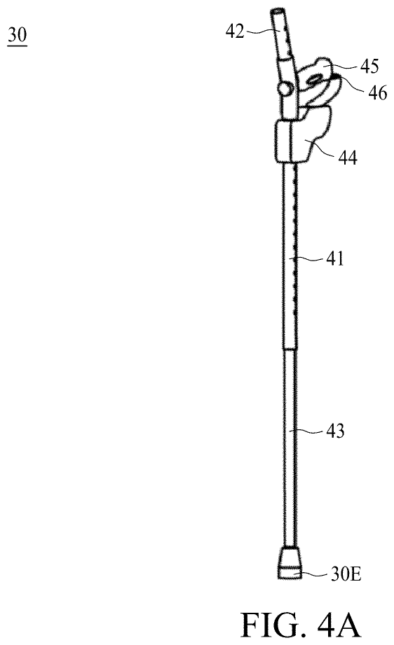

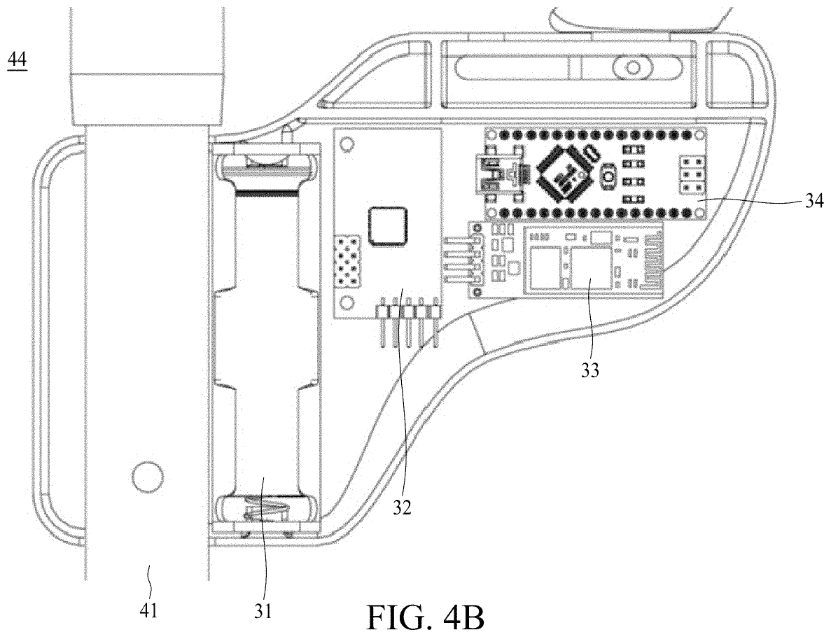

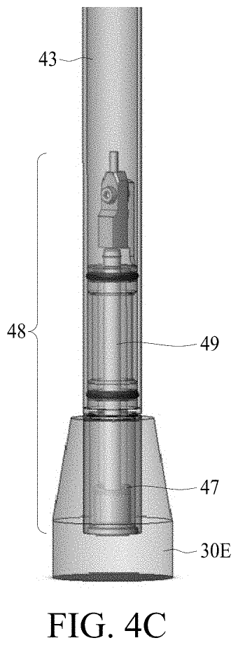

Referring to FIG. 3 and FIG. 4A, FIG. 3 is a schematic drawing illustrating an exoskeleton robot control system, and FIG. 4A is a perspective view of a crutch, in accordance with some embodiments of the present disclosure. It should be noted that the term, “crutch,” discussed in the present disclosure is not limited to the weight supporter. The crutch may include any peripheral devices (e.g. wearable device, controller, remote control, or the like), actuators or sensors associated to the crutch. In some embodiments, such peripheral devices, actuators or sensors may engage in communication with the crutch. In some embodiments, the peripheral devices, actuators or sensors can be physically separated from the crutch. The form of the crutch is also not limited herein, as the crutch can be in a form similar to any known walking aids devices, such as a walker. A user may utilize a first crutch 30 to control the exoskeleton 10. The first crutch 30 may include a first trajectory sensor 32, a control unit 34, a first communication module 33, and a main body 41. The first crutch 30 may optionally further include a battery 31, a first trigger 46, a first proximity sensor 48, a handle 45, an arm support tube 42, and/or an extendable tube 43. In some embodiments, the extendable tube 43 may be at least partially accommodated inside the main body 41, and the entire height of the first crutch 30 can be adjusted by stretching the extendable tube 43 outward or stowing the extendable tube 43 inward along an elongated direction of the first crutch 30. A fixture (not shown in FIG. 4A) may be utilized to fix the extendable tube 43 to the main body 41. In some other embodiments, the extendable tube 43 partially surrounds the main body 41. The arm support tube 42 is disposed on an upper portion of the first crutch 30, which can further enhance the stability with regard to supporting the user's upper body so that the user can at least partially lean on the first crutch 30. The handle 45 is disposed on the first crutch 30, wherein the handle 45 allows the user to hold the first crutch 30 by hands, or, the handle 45 may also bear weight of the user's forearm. In order to allow a user to grab on the handle 45 comfortably, a height of the handle 45 from the ground can be adjusted by adjusting a relative position between the extendable tube 43 and the main body 41 of the first crutch 30, i.e. extending or stowing the extendable tube 43.

Referring to FIG. 3, FIG. 4A, and FIG. 4B, FIG. 4B is a schematic drawing of a control box disposed on a crutch, in accordance with some embodiments of the present disclosure. In some embodiments, the battery 31, the control unit 34, the first trajectory sensor 32, and the first communication module 33 can be integrated and disposed inside a control box 44 disposed on the first crutch 30 in order to reduce the occupied space of the battery 31, the control unit 34, the first trajectory sensor 32, and the first communication module 33. In some embodiments, a size of the control box 44 is comparable to a user's arm. In some embodiments, the control box 44 is optionally disposed under the handle 45, and the user can rest his or her arm on the control box 44, wherein the control box 44 can bear the user's upper arm and/or lower arm. By such configuration, the user may be free from carrying the aforesaid devices in the control box 44 on the back.

Alternatively, the control unit 34 and/or the first communication module 33 can be physically separated from the first crutch 30. For example, the control unit 34 and the first communication module 33 can be disposed on devices physically separated from the first crutch 30, such as a computer. For a given computer, the software routines can be stored on a storage device, such as a permanent memory. Alternately, the software routines can be machine executable instructions stored using any machine readable storage medium, such as a diskette, CD-ROM, magnetic tape, digital video or versatile disk (DVD), laser disk, ROM, flash memory, etc. The series of instructions could be received from a remote storage device, such as a server on a network. The present invention can also be implemented in hardware systems, microcontroller unit (MCU) modules, discrete hardware or firmware.

The battery 31 is at least electrically connected to the control unit 34 in order to supply power thereto. The battery 31 may further be connected to one or more of the first trajectory sensor 32, the first communication module 33, the proximity sensor 48 (which will be subsequently discussed in FIG. 4C), and/or the first trigger 46 (which will be introduced subsequently). The first trajectory sensor 32 and the first communication module 33 can communicate with the control unit 34, through wire connection or wireless communication. The first communication module 33 may include a transmitter. The control unit 34 can communicate with the exoskeleton robot 10 through the first communication module 33, as the first communication module 33 can communicate with the exoskeleton robot 10 through wireless connection. In some embodiments, the first crutch is physically separated from the exoskeleton robot.

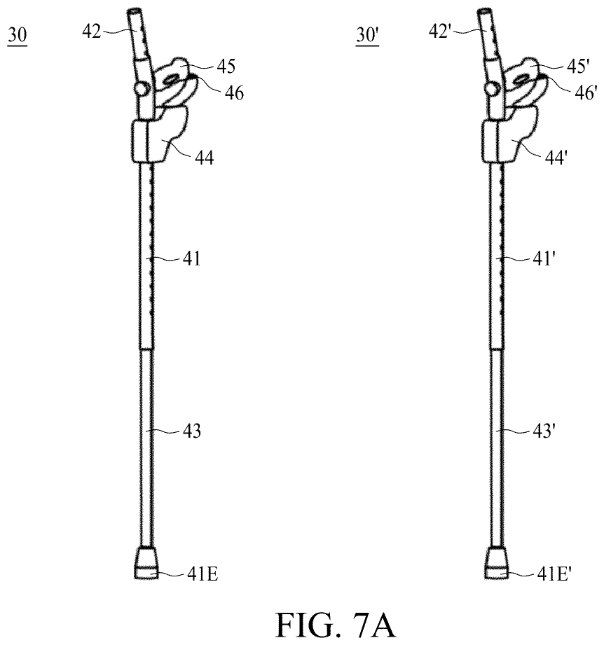

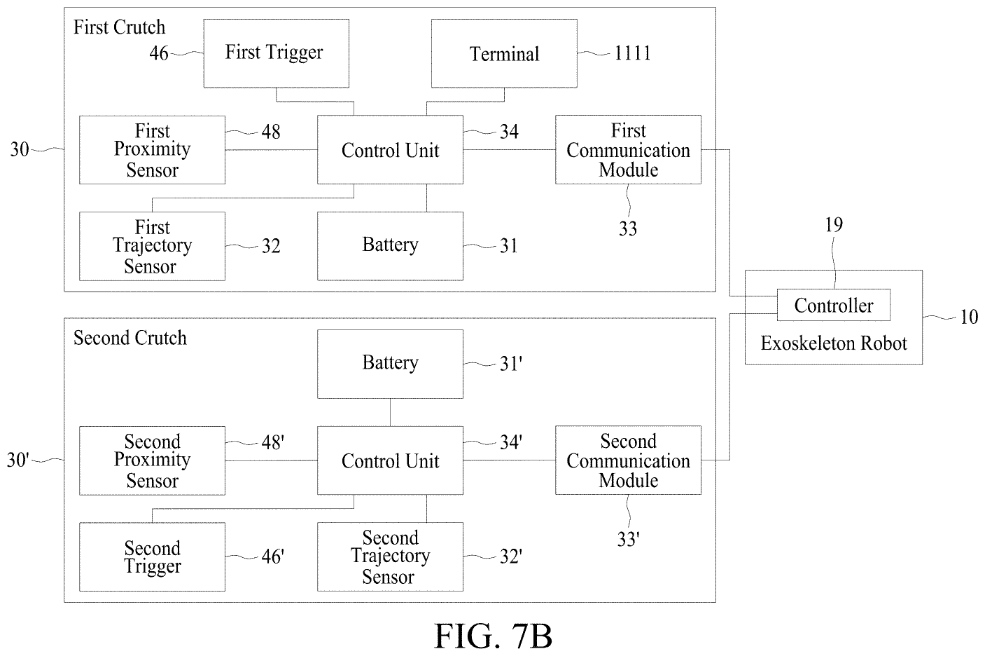

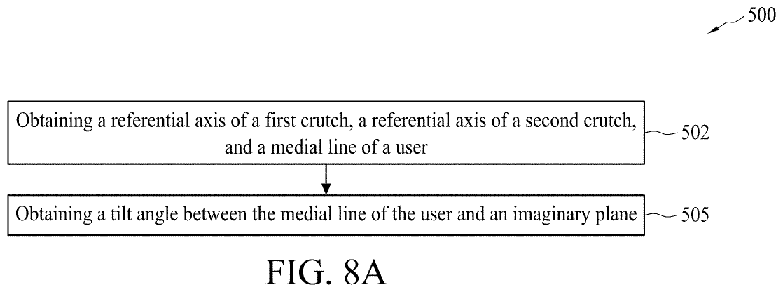

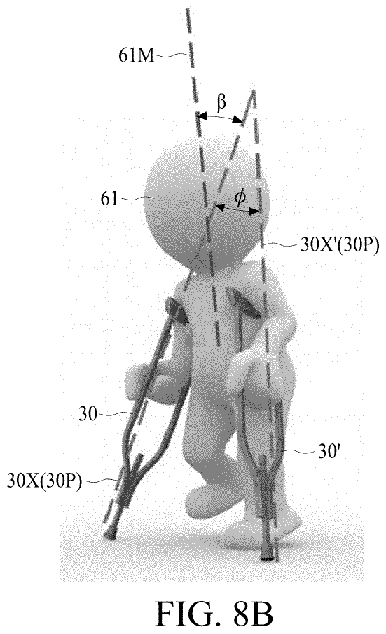

Referring to FIG. 3, FIG. 4A, and FIG. 4C, FIG. 4C is an enlarged perspective view of a tip of a crutch, in accordance with some embodiments of the present disclosure. The proximity sensor 48 is disposed on a tip 30E of the first crutch 30 (which can be an end of the extendable tube 43 or an end of the main body 41) proximal to the ground. The proximity sensor 48 is configured to detect if the tip 30E contacts with the ground. In some embodiments, the proximity sensor 48 may further detect a distance between the tip 30E and the ground. In some embodiments, the proximity sensor 48 can be a touch sensor, and a sensing bar 49 disposed inside the first crutch 30 is configured to be touched by the ground, and the proximity sensor 48 can detect change of the position of the sensing bar 49 so that a relative position between the tip 30E and the ground can be obtained. In some embodiments, an elastic member 47, such as a spring, can be utilized to restore the position of the sensing bar 49 to a predetermined neutral position. In some other embodiments, the proximity sensor 48 may include (or be substituted by) other sensors to obtain a relative position between the tip 30E and the ground, such as an infrared device, an optical device, a piezo touch switch, a resistance touch switch, a capacitance touch switch, or other suitable electronic sensors. The details of the use of the first proximity sensor 48 will be subsequently discussed in FIG. 7A to FIG. 8B.

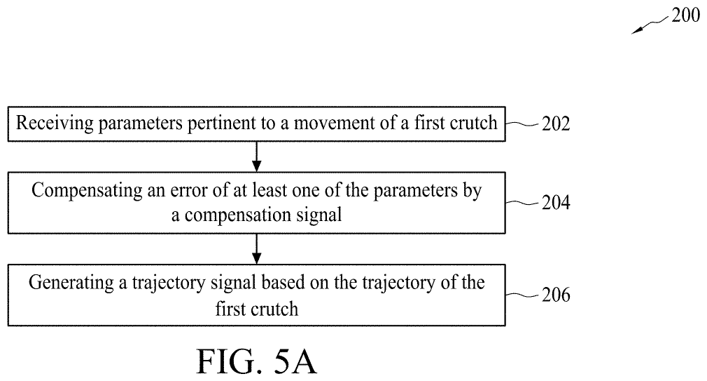

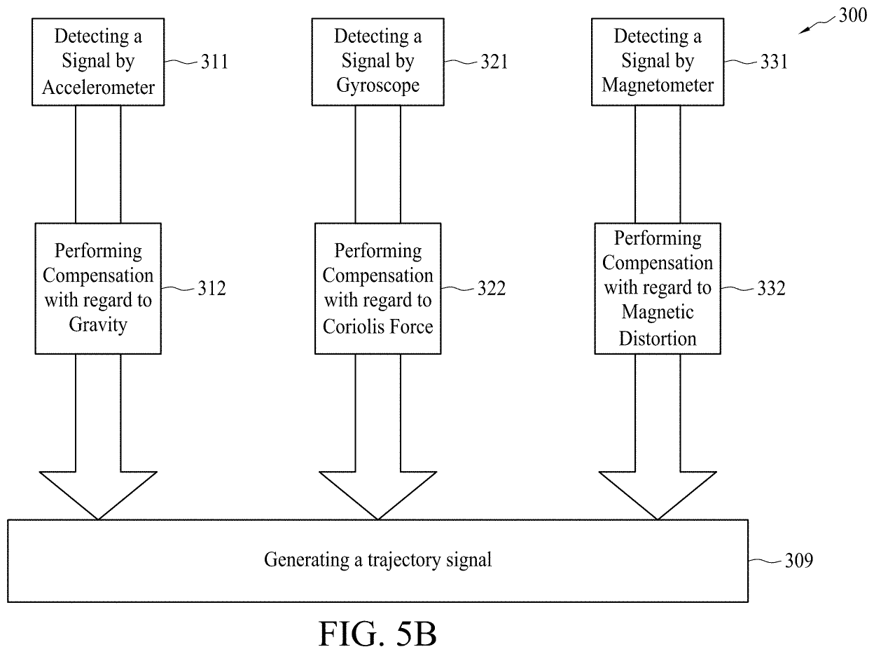

Referring back to FIG. 2, FIG. 3, and FIG. 4A, under operation 102 and operation 103, the first trajectory sensor 32 is configured to detect a trajectory of the first crutch 30 while the first crutch 30 is being moved along a trajectory. In some embodiments, the detection is simultaneously performed with the movement of the first crutch 30. The first trajectory sensor 32 obtains at least one parameters of the first crutch 30 during the movement along the trajectory, wherein the parameters may include one or more of an absolute velocity of the first crutch 30, an absolute position of the first crutch 30, angular velocity of the first crutch 30, acceleration of the first crutch 30, angular acceleration of the first crutch 30, ambient magnetic field, geomagnetic field, relative position of the first crutch 30 and the user, relative position of the first crutch 30 and the exoskeleton robot 30, relative position of the first crutch 30 and the ground, and/or relative position of the first crutch 30 and a predetermined reference point (e.g. a predetermined portion of the user). It should be noted that the absolute velocity of the first crutch 30 and the absolute position of the first crutch 30 may be respectively defined as velocity and position relative to Earth surface. Such parameters can be used for mapping a three-dimensional trajectory or a two-dimensional trajectory. In some embodiments, the detection of some parameters is continuously performed. In some embodiments, the detection of some parameters is obtained through sampling, and the sampling may be performed periodically. In some embodiments, the reference point of the movements for deriving parameters may be the first trajectory sensor 32 per se. Alternatively stated, the trajectory of the first crutch 30 can be derived into the parameters which can be detected by the sensors. The first trajectory sensor 32 may include at least one of an accelerometer, a gyroscope, or a magnetometer. The details of the first trajectory sensor 32 will be subsequently discussed in FIG. 5A to FIG. 5B.

In some embodiments, when the user is moving (e.g. walking, running, standing, sitting, or moving arms), trajectory of the first crutch 30 may also be unintentionally detected, which may cause the exoskeleton robot 10 to move in an undesirable and unintentional manner. In order to precisely detect the trajectory of the first crutch 30 in accordance with the user's intention, a first trigger 46 is optionally incorporated so that the trajectory of the first crutch 30 can be only detected within a predetermined time interval. An initiation of the predetermined time interval for detecting the trajectory of the first crutch 30 is firstly activated by the first trigger 46, and a termination of the predetermined time interval for detecting the trajectory of the first crutch 30 is subsequently activated by the first trigger 46. Alternatively stated, the predetermined time interval is decided by the first trigger 46. For exemplary demonstration, the first trigger 46 can be a button disposed on the first crutch 30, and the user can firstly press the first trigger 46 to start the operation of detecting the trajectory of the first crutch 30, and subsequently release the first trigger 46 to cease the operation of detecting the trajectory of the first crutch 30. For alternative exemplary demonstration, the first trigger 46 can be a button disposed on the first crutch 30, and the user can firstly press the first trigger 46 to start the operation of detecting the trajectory of the first crutch 30, and subsequently press the first trigger 46 again to cease the operation of detecting the trajectory of the first crutch 30. By such configuration, the movement of the first crutch 30 outside of the predetermined time interval may be hindered from being relayed, which may unintentionally instruct the exoskeleton to move in an unintentional manner.

The first trigger 46 is an actuator or sensor which can be triggered to instruct the first trajectory sensor 32 and/or the proximity sensor 48 to start and cease the detection of the trajectory of the first crutch 30. The first trigger 46 can be a button, a switch, a selection on a display screen, sensors, or the like. In some embodiments, the first trigger 46 is disposed on the first crutch 30 or extended from the first crutch 30. In some embodiments, the first trigger 46 is disposed on the handle 45. The first trigger 46 can be electrically connected to the control unit 34, or can alternatively be connected to the first trajectory sensor 32 and/or the proximity sensor 48. In some other embodiments, the first trigger 46 can wirelessly communicate with the control unit 34, the first trajectory sensor 32, or the proximity sensor 48. In some other embodiments, the first trigger 46 can be a switch for hindering communication between two of the control unit 34, the first trajectory sensor 32, the proximity sensor 48, or the first communication module 33. In some other embodiments, the first trigger 46 can also be hand-held devices or wearable devices disposed on a user's upper limb (e.g. wrist), which can be integrated into a device like smart watch, controller, or other suitable devices.

In some embodiments, a predetermined sound (e.g. beep sound, click sound, or the like) is generated by a speaker to indicate the initiation and/or the ceasing of the detection of the trajectory of the first crutch 30. In some embodiments, a light emitter is incorporated to emit light in order to indicate the initiation and/or the ceasing of the detection of the trajectory of the first crutch 30.

Alternatively, in some other embodiments, the first trigger 46 may further include or be substituted by a voice-operated switch. Specifically, the user can generate a specific sound to trigger the voice-operated switch in order to initiate or cease the detection of the trajectory of the first crutch 30.

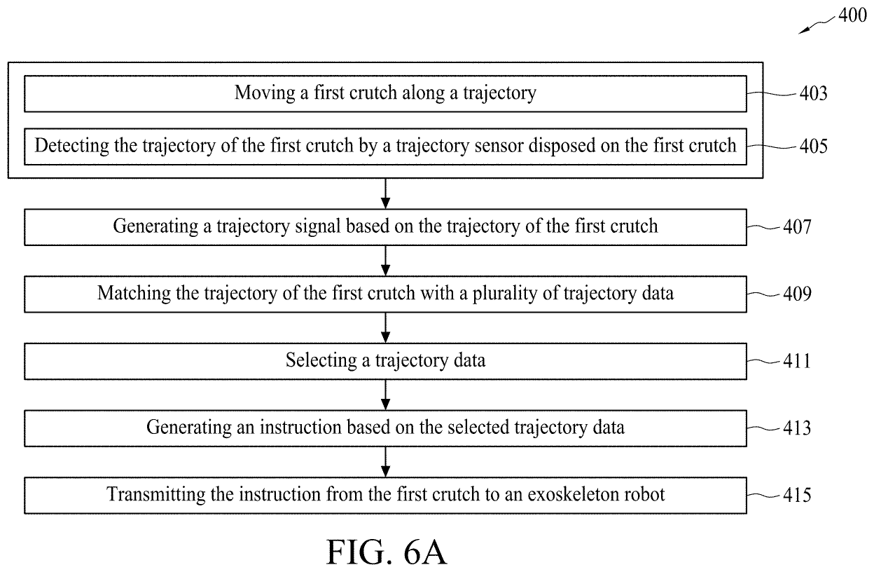

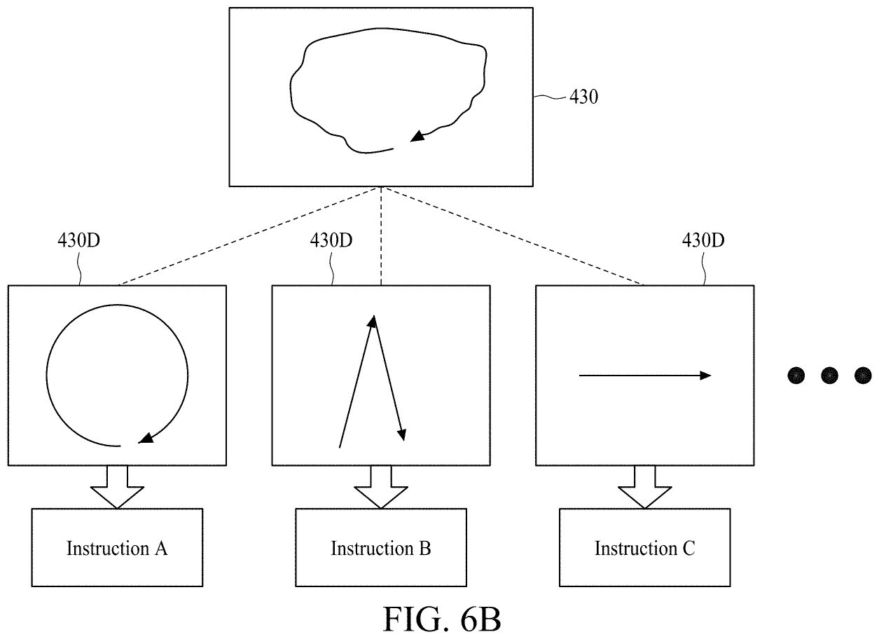

The first trajectory sensor 32 generates a trajectory signal, wherein the trajectory signal generated based on to at least one of the aforesaid parameters derived from the detected trajectory of the first crutch 30, wherein the parameters may include at least one of an absolute velocity of the first crutch 30, an absolute position of the first crutch 30, angular velocity of the first crutch 30, acceleration of the first crutch 30, angular acceleration of the first crutch 30, ambient magnetic field, geomagnetic field, relative position of the first crutch 30 and the user, relative position of the first crutch 30 and the exoskeleton robot 10, relative position of the first crutch 30 and the ground, and/or relative position of the first crutch 30 and a predetermined reference point. The details of methods for generating the trajectory signal will be subsequently discussed in FIG. 5A to FIG. 5B. Subsequent to generating the trajectory signal by the first trajectory sensor 32, the trajectory signal is transmitted to the control unit 34, and the control unit 34 generates an instruction based on the trajectory signal from the first trajectory sensor 32. The details of generating the instruction will be subsequently discussed in FIG. 5A to FIG. 6B. Subsequently the control unit 34 transmits the instruction to a controller 19 of the exoskeleton robot 10 by the first communication module 33. Thereby the controller 19 instructs the exoskeleton robot 10 to move in accordance to the instruction generated by the control unit 34. Alternatively stated, a subsequent movement of the exoskeleton robot 10 is decided by the instruction generated by the control unit 34, wherein the instruction is pertinent to the detected trajectory of the first crutch 30 within the predetermined time interval.

Alternatively, the first crutch 30 may optionally include a terminal 1111, wherein a trajectory of the terminal 1111 can be detected, and a trajectory signal can be derived from aforesaid parameters of such detected trajectory. For example, the terminal 1111 can be a wearable device, a watch, a hand-held controller, or the like. The terminal 1111 may, or may not be physically separated from the first crutch 30. Such configuration can further improve the accuracy of movement detection and/or providing an option for instructing the exoskeleton robot 10 by moving the terminal 1111 along a trajectory or changing an orientation of the terminal 1111. That is, the first trajectory sensor 32 can be disposed on the terminal 1111, and the trajectory of the terminal 1111 can be deemed as (or combined with) the trajectory of the first crutch 30. Alternatively, under certain circumstances, camera, optical range finders, ultrasonic range finders can be utilized to improve the accuracy of movement detection if potential obstructions thereto is not significant.

In some embodiments, the instruction can change the current state of the exoskeleton robot 10 coupled to the user. For example, the states of the exoskeleton robot 10 may include walking state, running state, sitting state, standing state, stopping state, or the like. The instruction can instruct the exoskeleton robot 10 to change a current state thereto, such as: (a) Under the sitting state, instruct the exoskeleton robot 10 to stand up (i.e. switch to standing state); (b) Under the standing state, instruct the exoskeleton robot 10 to sit (i.e. switch to sitting state); (c) Under the standing state, instruct the exoskeleton robot 10 to walk (i.e. switch to walking state); (d) Under the walking state, instruct the exoskeleton robot 10 to stop and stand (i.e. switch to standing state); (e) Under the walking state, instruct the exoskeleton robot 10 to increase moving speed (i.e. switch to running state); (f) Under the running state, instruct the exoskeleton robot 10 to decrease moving speed (i.e. switch to walking state); (g) Under the standing state, instruct the exoskeleton robot 10 to ascend/descend a slope, a stair, or a ladder, wherein a tilt angle of the user may be altered (i.e. switch to ascending/descending state); (h) Under the ascending/descending state, instruct the exoskeleton robot 10 to stop ascending/descending a slope, a stair, or a ladder, wherein a tilt angle of the user may be altered (i.e. switch back to standing state after ascending/descending state. Herein the tilt angle of the user will be subsequently discussed in FIG. 7A to FIG. 7B); (i) adjusting a current posture to a different posture, for example, after stop from walking or ascending/descending, the posture may be different from a neutral standing position, thus performing adjustment; or (j) instruct the exoskeleton robot 10 to abort current movement and resume to the previous state, the current movement includes any one of the aforesaid movement discussed in (a) to (i).

Referring to FIG. 5A, FIG. 5A shows a flow chart representing method for controlling an exoskeleton robot, in accordance with some embodiments of the present disclosure. A method 200 at least includes receiving parameters pertinent to a movement of a first crutch (operation 202), compensating an error of at least one of the parameters by a compensation signal (operation 204), and generating a trajectory signal based on the trajectory of the first crutch (operation 206).

Referring to FIG. 5B, FIG. 5B shows a flow chart representing a method 300 for generating a trajectory signal, in accordance with some embodiments of the present disclosure. In some embodiments, at least one sensor, such as an accelerometer, a gyroscope, and/or a magnetometer is included in the first trajectory sensor 32, so that the trajectory of the first crutch 30 can be mapped and/or characterized as certain parameters thereby a trajectory signal can be derived from the detected trajectory. In some embodiments, an accelerometer may be incorporated in the first trajectory sensor 32 and the accelerometer is configured to measure an acceleration of the accelerometer per se, which indicates an acceleration of a specific point of the first crutch 30. In some embodiments, a gyroscope may be incorporated in the first trajectory sensor 32 and the gyroscope is configured to measure an orientation and an angular velocity per se, which indicates an orientation and an angular velocity of a specific point of the first crutch 30. In some embodiments, a magnetometer may be incorporated in the first trajectory sensor 32 and the magnetometer is configured to measure a direction of an ambient magnetic field (e.g. geomagnetic field), which indicates a local orientation of the first crutch 30 deviated from Earth's magnetic field.

However in some embodiments, errors of the measurement of the trajectory of the first crutch 30 performed by the accelerometer, the gyroscope, and/or the magnetometer may be induced due to interference stems from various causes, which will be discussed subsequently. In order to compensate such errors, a compensation signal is generated to compensate such errors and compensate the first trajectory sensor 32, thus can provide a compensated trajectory signal thereby improve the accuracy of detected trajectory.

In some embodiments, since the accelerometer may measure its own proper acceleration, thus acceleration due to Earth's gravity may be measured and thereby interfere the generation of instruction. For example, an accelerometer rested on a surface may measure an acceleration of a ≈9.81 m/s² upward, while an accelerometer in free fall may measure an acceleration of a ≈0. Therefore the compensation signal may be pertinent to local gravity to compensate the proper acceleration, for example, transforming the detected proper acceleration into coordinate acceleration. Alternatively stated, subsequent to detecting a signal by the accelerometer (operation 311), compensation with regard to gravity is performed (operation 312).

In some embodiments, due to the transformation between the inertial reference and a non-inertial reference frames (e.g. rotating frame of reference), a trajectory of the first crutch 30 may be deflected due to Coriolis force effect. Specifically, because such rotational motion is non-inertial, a fictitious force can be invoked by using a rotational frame of reference. By incorporating compensation to Coriolis force effect in the compensation signal, errors can be alleviated when incorporating the gyroscope to the first trajectory sensor 32, and the complexity of calculation may be reduced. Alternatively stated, subsequent to detecting a signal by the gyroscope (operation 321), compensation with regard to Coriolis force effect is performed (operation 322).

In some embodiments, magnetometer can be interfered by ferromagnetic material or equipment in the vicinity. Generally speaking, magnetic interference can be divided into two types of effects: (1) Hard iron distortion effect, herein the magnetic interference stems from magnetic field (such as magnetic field induced by permanent magnet); and (2) Soft iron distortion effect, herein the magnetic interference stems from material that distorts a magnetic field, but such material does not necessarily generate a magnetic field itself (such as iron metal). For example, a speaker disposed on the first crutch 30 may be deemed as a source of hard iron distortion. For example, an iron-contained material used in the exoskeleton robot control system (such as used on the first crutch 30) may be deemed as a source of soft iron distortion. The compensation signal can be addressed to compensate the magnetic distortion stems from hard iron distortion effect and/or soft iron distortion effect. Alternatively stated, subsequent to detecting a signal by the magnetometer (operation 331), compensation with regard to magnetic distortion is performed (operation 332).

The trajectory signal is generated (operation 309) based on one or more of the signals obtained in operation 312, operation 322, and/or operation 332, wherein the signals detected by the first trajectory sensor 32 in operation 311, operation 321, and/or operation 331 (which are pertinent to parameters of detected trajectory of the first crutch 30) are compensated. It should be noted that the compensation signal discussed on the present disclosure may include one or more signals (either separated or combined), wherein compensation of each signal result from each sensor can be individually or collectively performed.

In some embodiments, the first proximity sensor 48 (shown in FIG. 3 and FIG. 4C) can indicate whether the first crutch 30 contacts the ground, or in some other embodiments, a distance between the tip 30E (shown in FIG. 4C) can be detected by the first proximity sensor 48. Such measurement of the first proximity sensor 48 may indicate an initial position and/or a final position of the first crutch 30 in the predetermined time interval of trajectory detection. By incorporating the signals obtained in operation 312, operation 322, and/or operation 332 with an initial position or a final position of the first crutch 30 in the predetermined time interval of trajectory detection, the absolute position of the first crutch 30, the relative position of the first crutch 30 and the user, relative position of the first crutch 30 and the exoskeleton robot 30, relative position of the first crutch 30 and the ground, and/or relative position of the first crutch 30 and a predetermined reference point (at least at certain time frames) may be partially or entirely mapped out, which can further improve the accuracy of trajectory detection.

Referring to FIG. 6A, FIG. 6A shows a flow chart representing method for controlling an exoskeleton robot, in accordance with some embodiments of the present disclosure. A method 400 at least includes moving a first crutch along a trajectory (operation 403), detecting the trajectory of the first crutch by a trajectory sensor disposed on the first crutch (operation 405), generating a trajectory signal based on the trajectory of the first crutch (operation 407), matching the trajectory of the first crutch with a plurality of trajectory data (operation 409), selecting a trajectory data (operation 411), generating an instruction based on the selected trajectory data (operation 413), and transmitting the instruction from the first crutch to an exoskeleton robot (operation 415).

Referring to FIG. 6A and FIG. 6B, FIG. 6B shows a diagram representing comparison between a trajectory of a first crutch and a plurality of trajectory data, in accordance with some embodiments of the present disclosure. A detected trajectory signal 430 is obtained in operation 405, wherein the trajectory signal 430 may be generated by compensation methods set forth in FIG. 5A to FIG. 5B. The trajectory signal 430 may be characterized as a three-dimensional path or two-dimensional path, or be characterized as a plurality of predetermined values, as will be discussed subsequently. The control unit 34 (shown in FIG. 3) further includes a memory (not shown in FIG. 3), wherein the memory stores a finite number of trajectory data 430D, and each of the trajectory data corresponds to an instruction for controlling a subsequent movement of the exoskeleton robot 10. The memory can include one or more non-transitory computer readable storage media, such as random access memory, hardware, disks, or memory devices. The detected trajectory signal 430 is compared to a plurality of trajectory data 430D and each of the similarity therebetween is gauged. Thus a trajectory data 430D having the highest similarity with the trajectory signal 430 is selected, thereby an instruction corresponds to the selected trajectory data 430D is generated and transmitted to the controller 19 of the exoskeleton robot 10 (shown in FIG. 3). The instruction instructs the exoskeleton robot 10 to move, wherein the instruction is based on the trajectory of the first crutch 30, and thereby a subsequent movement may be in accordance the user's intention. The subsequent movements may include changes of states as discussed in FIG. 3 to FIG. 4C.

In some embodiments, the similarity of the trajectory signal 430 and a given trajectory data 430D can be determined by a threshold value, wherein the threshold value may include one or more factors including a sum of each of a correlation coefficient of movement along x, y and z axis (of a predetermined inertial coordinate) respectively between the trajectory signal 430 and the given trajectory data 430D with regard to time, direction(s) of movement, distance of movement in certain direction, position and quantity of turning point(s), position and quantity of inflection point(s), change of movement, curvature, velocity, acceleration, angular velocity, angular acceleration, the absolute position of the first crutch 30, the relative position of the first crutch 30 and the user, relative position of the first crutch 30 and the exoskeleton robot 10, relative position of the first crutch 30 and the ground, and/or relative position of the first crutch 30 and a predetermined reference point, or the like. For exemplary demonstration, the user holds the first crutch 30 along a circular path, and a trajectory data 430D of the most similar path is selected, and the instruction corresponds to the selected trajectory data 430D is generated (in the case illustrated in FIG. 6B, instruction A is selected over instruction B and instruction C), transmitted to the controller 19 of the exoskeleton robot 10 and then executed.

It should be noted that in the present disclosure, an orientation of the first crutch 30 being changed or the first crutch 30 being rotated around an axis within the predetermined time interval of detection can be deemed as types of trajectories, which can be inferred into instruction. A stationary (resting) first crutch 30 within the predetermined time interval of detection can also be deemed as a type of trajectory, wherein the user can also place the first crutch 30 in a certain resting posture within the predetermined time interval of detection, for example, placing the tip 30E of the first crutch 30 behind the feet within the predetermined time interval of detection to instruct the exoskeleton robot 10 to change to sitting state. It should be noted that the present disclosure is not limited to such trajectory data-instruction relationship. The subsequent movements may include changes of states as discussed in FIG. 3 to FIG. 4C.

Referring to FIG. 7A and FIG. 7B, FIG. 7A is a perspective view of a first crutch and a second crutch, and FIG. 7B is a schematic drawing illustrating an exoskeleton robot control system, in accordance with some embodiments of the present disclosure. In some embodiments, in order to further improve the stability of the user, a second crutch 30′ can be incorporated in the exoskeleton robot control system to provide additional support. The first crutch 30 and the second crutch 30′ can be held by each hands of the user, so that both the first crutch 30 and the second crutch 30′ can bear the weight of the user. In some embodiments, the configuration of the second crutch 30′ can be similar to the first crutch 30 (which may be symmetric to the first crutch 30 in some embodiments) so that the second crutch 30′ may also generate an instruction to the controller 19 of the exoskeleton robot 10 by deriving a detected trajectory of the second crutch 30′. The second crutch 30′ may include a control unit 34′, a second trajectory sensor 32′, and a second communication module 33′. The second crutch 30′ may optionally further include a battery 31′, a second trigger 46′, and/or a second proximity sensor 48′. The description of the control unit 34′, the second trajectory sensor 32′, the second communication module 33′, the battery 31′, the second trigger 46′, and the second proximity sensor 48′ are similar to the counterparts in the first crutch 30, namely the control unit 34, the first trajectory sensor 32, the first communication module 33, the battery 31, the first trigger 46, and the first proximity sensor 48. In an alternative embodiment, only the first crutch 30 can generate instruction, wherein the first crutch 30 is held by the user's dominant hand.

Referring to FIG. 8A, FIG. 8A shows a flow chart representing method for controlling an exoskeleton robot, in accordance with some embodiments of the present disclosure. A method 500 at least includes obtaining a referential axis of a first crutch, a referential axis of a second crutch, and a medial line of a user (operation 502), and obtaining a tilt angle between the medial line of the user and an imaginary plane (operation 505).

Referring to FIG. 8B, FIG. 8B is a schematic drawing showing a relative position of a user, a first crutch, and a second crutch, in accordance with some embodiments of the present disclosure. In order to facilitate the performance of the exoskeleton robot control system, a relative position of a user, a first crutch and a second crutch can be further included in an instruction to the exoskeleton robot 10. Herein the relative position of a user, a first crutch and a second crutch can be indicated by a tilt angle β, wherein the tilt angle β is defined as: the tilt angle β is between an medial line 61M of the user 61 and the imaginary plane 40P, wherein a referential axis 30X of the first crutch 30 and a referential axis 30X′ of the second crutch 30′ are both on the imaginary plane 30P. (Alternatively stated, the referential axis 30X of the first crutch 30 and the referential axis 30X′ of the second crutch 30′ forms the imaginary plane 30P.) Herein the referential axis 30X of the first crutch 30 and the referential axis 30X′ of the second crutch 30′ can be a predetermined axis on the first crutch 30 and the second crutch 30′, for example, a medial axis of each of the first crutch 30 and the second crutch 30′. The intersection of extended referential axis 30X and referential axis 30X′ may intersect with each other since the first crutch 30 and the second crutch 30′ may be both placed under the armpits of the user 61, as a user's both shoulder joint are usually close to symmetric.

In order to obtain a more accurate tilt angle β, the second crutch 30′ at least include the control unit 34′, the second trajectory sensor 32′, and the second communication module 33′, and may further include the second proximity sensor 48′. The first proximity sensor 48 and the second proximity sensor 48′ indicates if the first crutch 30 and the second crutch 30′ contacts with the ground; while the first trajectory sensor 32 and the second trajectory sensor 32′ are configured to detect an orientation/posture of the first crutch 30 and the second crutch 30′.

The tilt angle β can be utilized to decide whether the user's current posture need to be adjusted (e.g. if the crutches are appropriately placed, the user tilts forward/backward too much, or the slope being too steep), and such tilt angle β can be incorporated to the generation of instruction to the exoskeleton robot 10. For example, if the tilt angle β is greater than predetermined value, then the exoskeleton robot 10 is instructed to reduce the tilt angle β. In some embodiments, an angle Ø between the referential axis 30X of the first crutch 30 and the referential axis 30X′ of the second crutch 30′ can also be obtained, wherein the angle Ø indicates if the first crutch 30 and the second crutch 30′ are too widely separated.

In order to provide a more accurate control over the exoskeleton robot and to alleviate the potential of providing undesirable instruction to exoskeleton robot, the present disclosure provides an exoskeleton robot control system and methods for controlling an exoskeleton robot. Some of the embodiments provide an exoskeleton robot control system with sensors incorporated on the crutch to obtain more accurate movement and/or relative position between the crutch and the user, so that a trajectory of the crutch can be used to generate an instruction for the exoskeleton robot to decide a subsequent movement of the exoskeleton robot. By incorporating sensors on the crutch, obstructions hindering the detection of a trajectory or an orientation of the crutch can be alleviated. Some of the embodiments provide an exoskeleton robot control system configured with triggers to avoid unintentional instructions when the user has no intention to instruct the exoskeleton robot. The user can utilize the trigger to initiate or cease the detection of the trajectory of the crutch, therefore the trajectory of the crutch within a predetermined time interval is detected and utilized to generate instructions. In some of the embodiments, since the crutch can bear a portion of user's weight, by incorporating the sensors on the crutch, the user may be free from being coupled to heavy sensors. The present disclosure further provides methods for controlling an exoskeleton robot with matching the trajectory signal generated based on detected trajectory of crutch to different trajectory data, so that different instruction can be executed by moving the crutch in different manner. The present disclosure further provides methods for controlling an exoskeleton robot with improved accuracy, for example, with regard to incorporating sensors on the crutch, compensation on detected signals can be performed, and a tilt angle of the user can be detected to decide if current posture should be adjusted.

Some embodiments of the present disclosure provide an exoskeleton robot control system, including an exoskeleton robot coupled to a user, a first crutch configured to be held by a user, wherein the first crutch is physically separated from the exoskeleton robot, a trajectory sensor disposed on the first crutch, wherein the trajectory sensor is configured to detect a trajectory of the first crutch, and a control unit configured to generate an instruction based on the detected trajectory of the first crutch, wherein the instruction is received by the exoskeleton robot, and a subsequent movement of the exoskeleton robot is decided by the instruction.

Some embodiments of the present disclosure provide method for controlling an exoskeleton robot, including moving a first crutch along a trajectory, detecting the trajectory of the first crutch by a trajectory sensor disposed on the first crutch, generating an instruction based on the trajectory of the first crutch, and transmitting the instruction from the first crutch to an exoskeleton robot coupled to a user.

The foregoing outlines features of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An exoskeleton robot control system, comprising:
an exoskeleton robot coupled to a user;
a first crutch configured to be held by a user, wherein the first crutch is physically separated from the exoskeleton robot;
a trajectory sensor disposed on the first crutch, wherein the trajectory sensor is configured to detect a trajectory of the first crutch; and
a control unit configured to generate an instruction based on the detected trajectory of the first crutch, wherein the instruction is received by the exoskeleton robot, and a subsequent movement of the exoskeleton robot is decided by the instruction.

2. The exoskeleton robot control system of claim 1, wherein the trajectory sensor comprises at least one of an accelerometer, a gyroscope, and a magnetometer.

3. The exoskeleton robot control system of claim 1, wherein a trajectory signal is generated by the trajectory sensor, the trajectory sensor is to at least one of the absolute velocity of the first crutch, absolute position of the first crutch, angular velocity of the first crutch, acceleration of the first crutch, angular acceleration of the first crutch, ambient magnetic field, geomagnetic field, relative position of the first crutch and the user, relative position of the first crutch and the exoskeleton robot, relative position of the first crutch and the ground, and relative position of the first crutch and a predetermined reference point.

4. The exoskeleton robot control system of claim 3, wherein the control unit generates the instruction in accordance with the trajectory signal.

5. The exoskeleton robot control system of claim 1, further comprising a trigger, the trigger is configured to initiate and cease the detection of the trajectory of the first crutch.

6. The exoskeleton robot control system of claim 1, wherein the control unit is disposed on the first crutch.

7. The exoskeleton robot control system of claim 1, wherein the control unit further comprises a memory, the control unit compares the detected trajectory of the first crutch with a plurality of trajectory data stored by the memory.

8. The exoskeleton robot control system of claim 7, wherein the instruction is generated based on a selected trajectory data from the memory.

9. The exoskeleton robot control system of claim 1, wherein the instruction instructs the exoskeleton robot to initiate at least one of the states of walking, sitting, standing, running, ascending, descending, stopping, and aborting a current movement.

10. The exoskeleton robot control system of claim 1, further comprising a second crutch with a trajectory sensor disposed thereon, wherein a referential axis of the first crutch and a referential axis of the second crutch are on an imaginary plane, and a tilt angle is between a medial line of the user and the imaginary plane.

11. A method for controlling an exoskeleton robot, comprising:
moving a first crutch along a trajectory;
detecting the trajectory of the first crutch by a trajectory sensor disposed on the first crutch;
generating an instruction based on the trajectory of the first crutch; and
transmitting the instruction from the first crutch to an exoskeleton robot coupled to a user.

12. The method of claim 11, further comprising generating a trajectory signal by the trajectory sensor, wherein the trajectory signal is pertinent to at least one of the absolute velocity of the first crutch, absolute position of the first crutch, angular velocity of the first crutch, acceleration of the first crutch, angular acceleration of the first crutch, ambient magnetic field, geomagnetic field, relative position of the first crutch and the user, relative position of the first crutch and the exoskeleton robot, relative position of the first crutch and the ground, and relative position of the first crutch and a predetermined reference point.

13. The method of claim 11, further comprising activating a trigger to initiate the detecting the trajectory of the first crutch.

14. The method of claim 12, wherein the detecting the trajectory of the first crutch is performed within a predetermined interval, a termination of the predetermined interval is activated by the trigger.

15. The method of claim 12, further comprising compensating the trajectory signal by a compensation signal, wherein the compensation signal is pertinent to at least one of the gravity, Coriolis force, and magnetic distortion.

16. The method of claim 11, further comprising matching the trajectory of the first crutch with a plurality of trajectory data.

17. The method of claim 16, further comprising selecting a trajectory data that has a highest similarity with the trajectory of the first crutch from the plurality of trajectory data.

18. The method of claim 17, wherein the instruction is generated in accordance with the selected trajectory data, and a subsequent movement of the exoskeleton robot is determined by the instruction.

19. The method of claim 11, further comprising switching a state to another state of the exoskeleton robot in accordance with the instruction, wherein the movement states of the exoskeleton robot comprises at least two of the walking state, sitting state, standing state, running state, ascending state, descending state, and stopping state.

20. The method of claim 11, further comprising obtaining a tilt angle, wherein the tilt angle is between an medial line of a user and the imaginary plane, wherein a referential axis of the first crutch and a referential axis of a second crutch are on the imaginary plane, the first crutch and the second crutch are held by the user.
